(19) United States
(12) Patent Application Publication
(10) Pub. No.: US 2017/0031182 A1
(43) Pub. Date: Feb. 2, 2017

(54) Light Flicker Canceling Glasses

(71) Applicant: Gordon Shaw Novak, West Lake Hills, TX (US)

(72) Inventor: Gordon Shaw Novak, West Lake Hills, TX (US)

(21) Appl. No.: 15/173,168

(22) Filed: Jun. 3, 2016

Related U.S. Application Data
(60) Provisional application No. 62/171,067, filed on Jun. 4, 2015.

(51) Int. Cl. G02C 7/10

(52) U.S. Cl. CPC G02C 7/101; G02C 7/104; G02C 7/105

(57) ABSTRACT

Most electric light sources flicker, that is, the intensity of the light that is produced varies substantially in a periodically repeating pattern. In sensitive individuals, light flicker can cause headaches and other undesirable symptoms. This invention comprises a light sensor that measures light intensity, signal processing that identifies the flicker component of the light, and electrically controlled lenses of glasses (spectacles) that rapidly darken or become more transparent so as to cancel most of the flicker. This reduces the flicker seen by the wearer of the glasses, reducing discomfort.

This application is entitled to the benefit of Provisional Patent Application Ser. No. 62/171,067 filed Jun. 4, 2015.

### TECHNICAL FIELD

The present invention relates generally to variable density lenses and more particularly toward fast response time variable density lenses wherein density is controlled as a function of ambient light intensity to reduce light flicker. The present invention also relates generally to therapeutic or protective eyewear to prevent injurious or unpleasant light from reaching the eyes of the wearer.

### BACKGROUND ART

Most electric light sources that are powered by alternating current (AC) electricity flicker, that is, the intensity of the light produced by the light source varies substantially and rapidly as a periodic function of time. Flickering light sources include fluorescent lights, compact fluorescents, light emitting diode (LED) lights, television screens, movie projectors, and computer screens. Light dimmers that use pulse-width modulation (PWM) also introduce flicker: the apparent dimming of the light is caused by rapidly switching the electric power (and therefore the light) on and off.

Electric lights commonly flicker at twice the frequency of the electric power source [3] [1] [2], with a waveform that is approximately sinusoidal or similar to a full-wave rectified sinusoid. For 60 Hertz AC electricity, the primary flicker frequency is 120 Hertz. Because 120 Hertz is above the so-called flicker fusion frequency, light with 120 Hertz flicker usually is not perceived as flickering by humans. However, flicker at this frequency can be detected by neural circuits in the brain [5], and in sensitive individuals flicker can cause undesirable symptoms, including headache, fatigue, distraction, and reduced productivity [5] [6].

Although an individual might be able to control light flicker at home, it is usually not possible for an individual to control light source flicker in public locations such as workplaces, commercial buildings, and outdoor locations such as streets and stadiums at night. There is a need for individuals to be able to ameliorate flicker due to ambient artificial lighting, television screens, and computer screens.

In an indoor environment, there may be multiple sources of flicker, such as office lights and computer screens, and the flicker experienced by an individual can vary with the body motion and head motion of the individual.

Electrochromic lenses, that is, lenses whose light transmissability can be controlled by an applied electric voltage, have been used in several kinds of products. One such product is automatically darkening welding helmets, which darken when the intense light of a welding arc is detected. Glasses for 3-dimensional (3D) television viewing have been produced that alternately darken each lens in synchrony with the television screen, so that a different picture is presented to each eye and the brain can interpret the pair of images as a 3D image. Electrochromic lenses have also been used to control light transmission of camera lenses.

The present invention comprises glasses containing a pair of electrochromic lenses whose light transmissibility is electronically controlled (such as liquid crystal lenses or other electrochromic technology), a photodetector that senses the intensity of incident visible light, signal processing to detect and separate the flicker component of the incident light, and amplification and control circuitry that rapidly adjusts the light transmissibility of the electronically controlled lenses so that the flicker component of the incident light is counteracted and reduced. By substantially canceling the flicker component of artificial light, these glasses can reduce the unpleasant effects that light flicker can have on sensitive individuals.

One object of the present invention, therefore, is to provide variable density lenses that have a response time faster than the flicker component of artificial lighting sources.

Another object is to provide a fast response time variable density lens that is automatically controlled to substantially cancel the flicker component of light produced by artificial light sources.

Another object is signal processing to identify and separate the periodic flicker components of the ambient light, so that the flicker can be canceled without impeding variations in lighting that should be seen, such as those variations due to motion of objects in the field of vision, motion and variability in a television image, motion of the wearer of the glasses, and so forth.

Another object is to provide lenses having a density that is variable within a wide density range in response to flicker intensity and has a fast response time to allow the lens density to change rapidly in order to substantially cancel light flicker.

Another object is to provide therapeutic lenses having continuously variable controlled density, to ameliorate the undesirable symptoms produced in susceptible individuals by light flicker.

### DISCLOSURE OF INVENTION

A spectacle lens, in accordance with the invention, comprises a layer of liquid crystal or other electrochromic material sandwiched between a pair of identically curved lenses made of glass, plastic, or other transparent material. Opposite outer surfaces of the electrochromic layer are in contact with transparent electrically conductive electrodes. The light transmission density of the assembly is controlled as a function of the voltage applied to the electrodes.

A photodetector is employed that produces an output voltage that is proportional to or varies with the intensity of ambient visible light over a wide range of light intensity. It is necessary that the photodetector respond to changes in light intensity much faster than the highest flicker frequency to be cancelled; a frequency response of 2000 Hertz is twice as fast as the maximum firing rate of neurons in the brain and is considered sufficient.

The output of the photodetector forms the input to a means of signal processing, such as analog circuitry or digital signal processing by a small computer processor. The signal processing may include bandpass filtering, to isolate the flicker component of the ambient light so that the flicker component can be canceled without canceling other variations in the light that should be perceived. More sophisticated signal processing, including but not limited to Fourier spectral analysis and autocorrelation, memory of the flicker waveform, prediction of the future waveform, and use of a model of the time response of the electrochromic lens for predictive darkening, allow more precise cancellation of the flicker component.

The output of the signal processing module is the input to a control module that amplifies the control signal and adjusts it to the level appropriate to control the light transmission density of the lenses of the glasses. This control can be improved by additional measurement of the light behind the lens and separate measurement of light transmission through the lens to ensure that the flicker is effectively canceled.

Liquid crystal lenses have been used in the past for automatically adjusting the light transmissibility of glasses. U.S. Pat. No. 4,701,912 covers use of a liquid crystal lens in a welding helmet; such a helmet varies automatically between maximum transparency and minimum transparency.

U.S. Pat. No. 4,279,474 describes automatically controlled and continuously variable density glasses, as might be used for sunglasses. However, because that invention uses pulse width modulation (PWM) to control the lens density, that invention imposes substantial flicker onto largely non-flickering natural sunlight and would be unsuitable for flicker cancellation.

U.S. Pat. No. 7,874,666 describes automatically controlled and continuously variable density glasses, as might be used for sunglasses, using different technology than the older liquid crystal technology. This patent does not discuss flicker, nor the techniques necessary to reduce flicker.

### BRIEF DESCRIPTION OF THE DRAWINGS

FIG. 1 is a perspective view of a pair of glasses equipped with the light sensor and variable density lenses of the present invention.

FIG. 2 is a simplified block diagram showing circuitry for controlling the density of the lenses as a function of light intensity at the light sensor.

FIG. 3 is a more detailed circuit diagram of one possible implementation of the control circuitry of FIG. 2.

FIG. 5 is a photograph of an implemented version of flicker canceling glasses using an analog control circuit as in FIG. 3; the electronic components of the control circuit are hidden within the frames of the glasses.

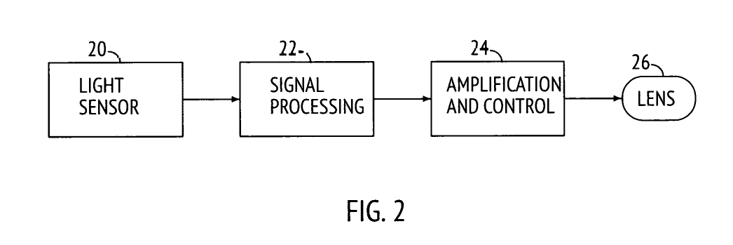

FIG. 4 is a more detailed diagram of a second possible implementation of the control circuitry of FIG. 2 using digital signal processing performed by a small computer processor.

FIG. 6 shows an example of the flicker waveform produced by a compact fluorescent bulb as measured by an AMS-TAOS TSL251 light sensor, converted to digital values by an analog-to-digital (A/D) converter and stored in the memory of a computer processor as in the diagram of FIG. 4. This bulb has a flicker percentage of 9% and a fundamental flicker frequency of 120 Hz.

FIG. 7 is a photograph of an implemented version of flicker canceling glasses using a Teensy [4] computer processor.

### BEST MODE FOR CARRYING OUT THE INVENTION

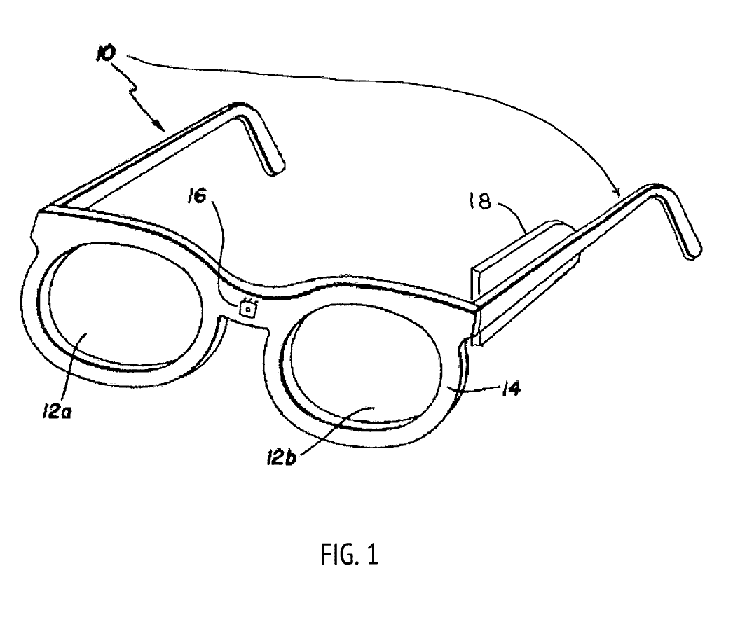

Referring to FIG. 1, a pair of glasses 10, 14 comprises a frame 14 carrying a pair of substantially identical variable density lenses 12a and 12b each containing a liquid crystal layer or other electrochromic medium whose light transmissibility is controlled by an applied electric voltage. A light sensor 16 is attached to the front of the glasses and detects the overall light intensity at the front of the glasses; the light sensor has a fast response time so that it can rapidly detect changes in light intensity due to flicker of light sources. A battery case 18 is attached to a temple piece 10 of the glasses and contains batteries to power the circuitry and an on/off switch. Preferentially, the wiring and circuit components of the invention are miniaturized and are contained within the frame 14 of the glasses.

Referring now to FIG. 2, the output of the light sensor 20 forms the input to a signal processing module 22 that isolates and enhances the flicker component of the incident light. The output of the signal processing module 22 forms the input to the amplification and control module 24, which increases the electrical signal to be strong enough and of an appropriate voltage to control the density of the electrochromic lens 26.

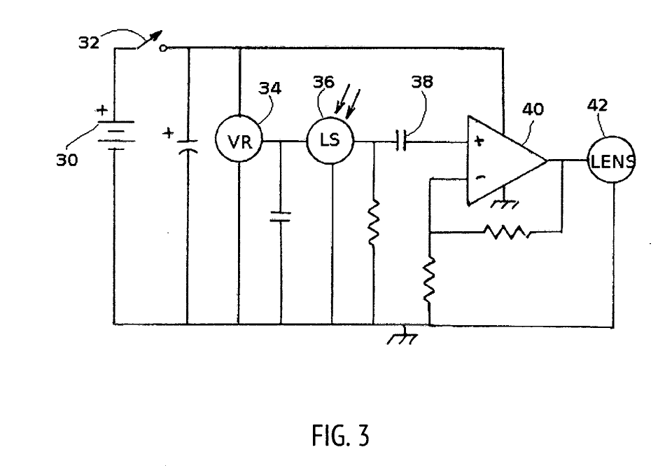

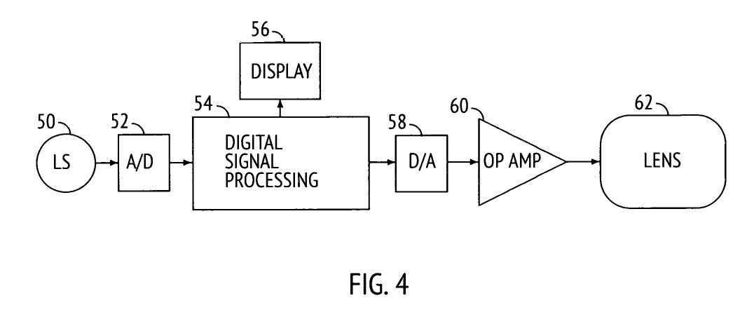

Referring now to FIG. 3, the circuit diagram of an implementation of the invention is shown. The lenses as used in this implementation are adapted from a pair of Sony PlayStation 3 active shutter glasses; the circuitry of the Sony glasses is removed, and the circuit described in FIG. 3 is used instead. Components in the circuit of FIG. 3 are:
30 Battery, 2×CR2032
32 Switch
34 Voltage Regulator, 5 volts
36 Light Sensor, AMS-TAOS TSL251
38 Capacitor
40 Operational Amplifier, Texas Instruments TLV2772
42 Photochromic Lenses from Sony Playstation 3 glasses

Referring again to FIG. 3, the battery 30 and switch 32 provide power for the circuit. The voltage regulator 34 controls the battery voltage to be at the voltage required by the light sensor 36. The capacitor 38 couples the output of the light sensor 36 to the operational amplifier 40 and provides signal processing (high-pass filtering) to isolate the flicker component of the incident light. The operational amplifier 40 amplifies the signal to be at an appropriate voltage and current to control the lenses 42.

In the preferred embodiment of this invention, the wiring, circuitry, and batteries used for the invention are miniaturized and hidden inside the frame 14 in FIG. 1 of the glasses, or are enclosed in small modules attached to the temple pieces 10 in FIG. 1 of the glasses.

The flicker canceling glasses of the present invention have been implemented, and they have been tested by a person who suffers from migraine headaches and who finds that flickering light sources cause headaches. The test subject reported that the glasses of the present invention were effective in preventing headaches caused by light flicker.

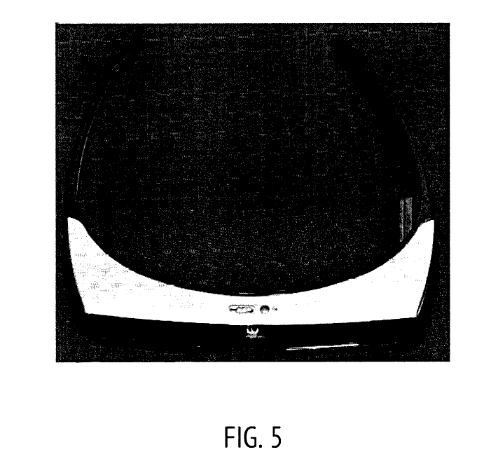

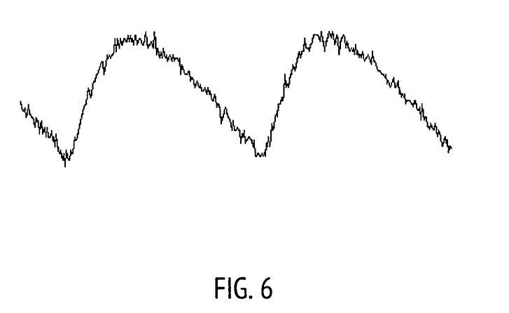

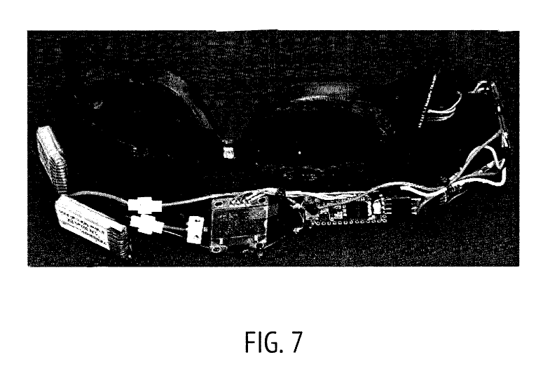

FIG. 5 shows a photograph of an implementation of the flicker canceling glasses using the analog circuitry of FIG. 3. The glasses used are Sony Playstation glasses in which the circuitry has been removed and replaced by the circuitry of the present invention.

A second embodiment of the present invention uses digital signal processing as shown in FIG. 4. The electrochromic lenses used in the glasses do not respond instantly to a control signal; instead, the electrochromic lenses act in a manner similar to a resistor-capacitor (RC) series circuit and darken or lighten gradually in response to a control signal. Because of this delayed response, directly deriving the control signal from measurement of the ambient light intensity, as in the circuit of FIG. 3, results in lens darkening that lags behind the light flicker and gives less cancellation than is desired.

Referring now to FIG. 4, the intensity of light at the front of the glasses is converted to a voltage by the light sensor 50; this voltage is converted to a digital value by the analog-to-digital converter 52 and is input to a small computer processor labeled 54. The computer performs storage of the waveform values and computes a control signal that will cause the lens to approximately cancel the light flicker. The control signal is converted back to an electrical voltage by the digital-to-analog converter 58; this signal is amplified by the operational amplifier 60 and forms the control input voltage to the Lens 62.

The second embodiment of the present invention using a small computer processor, as shown in FIG. 4 allows more precise control of the lens to achieve better cancellation. The measurement of light intensity by the photocell is digitized using an analog-to-digital (A/D) converter, and sampled intensity values spanning a plurality of flicker waveforms are stored in a circular buffer in the memory of the computer processor, as shown in FIG. 6. The computer determines synchronization points of the flicker waveform (crossings of the average light intensity value with positive slope), maximum and minimum intensity values, and flicker waveform wavelength. The computer subtracts a bias value from the input light intensity and varies the control voltage for the lens to produce improved flicker cancellation. In particular, the computer overcomes the time delay imposed by the response time of the photochromic lens by making the assumption that the flicker waveform for the present cycle will be approximately the same as the waveform for the previous cycle: by looking backward into the stored memory of the previous waveform, the computer predicts what the ambient light intensity will be at a future time and adjusts the photochromic lens control voltage so that the lens will be at the desired darkness at the future time. A further improvement can be made by using a mathematical model of the lens response within the computer program to compute the control voltage needed at the present time to produce desired lens responses at future times.

FIG. 7 shows a photograph of an embodiment of the flicker canceling glasses using digital signal processing on a Teensy microprocessor [4], as described in the block diagram of FIG. 4 and the above paragraphs. Referring now to FIG. 7, the light sensor is mounted on the center bridge of the glasses, above the nose of the wearer. The electronic components are attached to the elastic headband of the glasses. From left to right in the photograph of FIG. 7, the components are batteries, on-off switch (white with 0-1 markings), display 56 in FIG. 4 (showing a random pattern in this photo), Teensy processor board (with orange light) 52, 54, 58 in FIG. 4, and OpAmp circuit board (below the yellow wire) 60 in FIG. 4. The C++ computer software used for this implementation is shown in APPENDIX A. The glasses of FIG. 7 have been tested, by a person who suffers from flicker-induced migraine headaches, in an auditorium with fluorescent lighting. The subject found the glasses to be effective in reducing flicker discomfort.

### REFERENCES

[1] Wanda Lau, “Fighting Flicker,” Architectural Lighting, http://www.archlighting.com/leds/leds-fighting-flicker_o.aspx
[2] Brad Lehman, A. Wilkins, S. Berman, M. Poplawski, and N. Miller, “Proposing measures of flicker in the low frequencies for lighting applications,” Energy Conversion Congress and Exposition (ECCE), 2011 IEEE, pp. 2865-2872.
[3] Michael Poplawski and Naomi J. Miller, “Exploring flicker in SolidState Lighting: What you might find, and how to deal with it,” Pacific Northwest National Laboratory, 2011. Available at bit.ly/1hgwlrH.
[4] www.pjrc.com/teensy
[5] A. J. Wilkins, I. NimmoSmith, A. I. Slater, and L. Bedocs, “Fluorescent lighting, headaches and eyestrain,” Lighting Research and Technology, vol. 21, no. 1, p. 11, 1989.
[6] Frances Wilkinson, “Detection and discrimination of flicker contrast in migraine.” Cephalagia, Pubmed 21493642.

What is claimed is:

1. Glasses (spectacles) having lenses with variable light transmission density that is controlled by an applied electric voltage, a light sensor capable of sensing visible light and having a fast response time, and amplification and control circuitry suitable for controlling the voltage applied to the lenses so as to cancel the majority of the flicker that is present in the incident light.

2. The glasses of claim 1, with signal processing to identify and isolate the flicker component of incident light, whether said signal processing is performed by analog electronic circuitry, digital electronic circuitry, digital computer processing, or any combination of these.

3. The glasses of claim 1 or claim 2, where signal processing techniques are used, which may include low-pass filtering, high-pass filtering, bandpass filtering, Fourier spectral analysis, autocorrelation, time delays, feedback, or other advanced techniques.

4. The glasses of claim 1 or claim 2, where an adjustment control is provided to allow the wearer of the glasses to adjust the overall darkness of the lenses.

5. The glasses of claim 1 or claim 2, where an adjustment control is provided to allow the wearer of the glasses to adjust the degree of cancellation of the flicker component of incident light.

6. The glasses of claim 1 or claim 2, incorporating a memory component in which a representation of the flicker waveform of the light can be stored, and the use of this memory of the flicker waveform to improve cancellation of the flicker by the variable density lens.

7. The glasses of claim 1 or claim 2, using a digital camera as a light sensor and incorporating signal processing of the camera output to control lens densities.

8. The glasses of claim 1 or claim 2, incorporating a digital camera or light sensors that can sense light intensity in a plurality of separate areas or pixels, and incorporating photochromic lenses that allow darkening of separate areas or pixels, and incorporating signal processing of the light intensity measured by the light sensors to control the lens densities of the areas or pixels of the phototchromic lens to cancel flicker or light impulses within those areas.

9. The glasses of claim 1 or claim 2, incorporating one or more additional light sensors behind the variable density lens, and the use of the signal provided by the additional sensors to improve control of the variable density lens.

10. The glasses of claim 1 or claim 2, incorporating one or more additional light sensors behind the variable density lens, as well as one or more independent light sources in front of the lens, to measure the photochromic density of the lens, and the use of said measurements to improve flicker cancellation.

11. The glasses of claim 1 or claim 2, incorporating feedback control or machine learning to improve the cancellation of flicker.

12. The use of the techniques of the above claims to control the density of a window, windshield, face shield, camera lens, or other variable density transparent media, to remove flicker or to defend against possibly harmful or distracting light sources such as lasers aimed at a driver, pilot, military soldier, or public safety officer.
